(19) United States
(12) Patent Application Publication
(10) Pub. No.: US 2017/0360065 A1
(43) Pub. Date: Dec. 21, 2017

(54) PROCESS AND METHOD OF SUSTAINABLE IMPROVEMENT OF SEAFOOD PRODUCTION IN OCEAN WATERS

(71) Applicant: Lucent Biosciences, Inc., Vancouver (CA)

(72) Inventor: Peter Gross, West Vancouver (CA)

(21) Appl. No.: 15/534,695

(22) PCT Filed: Dec. 8, 2015
(86) PCT No.: PCT/CA2015/051291

§ 371 Date: Jun. 9, 2017

(30) Foreign Application Priority Data
Dec. 9, 2014 (CL) 3349-2014

(51) Int. Cl. A23K 50/80; A23K 20/163; A23K 20/20; A01K 61/00

(52) U.S. Cl. CPC A23K 50/80; A23K 20/30; A23K 20/163; A01K 61/00

(57) ABSTRACT

Disclosed is a method and process for manifesting sustainable improvement in fisheries productivity in Ocean waters. This method and process includes (1) selecting a location of the Ocean that is considered both High Nutrient Low Chlorophyll (HNLC), (2) that the location is within proximity to fisheries feeding grounds or migratory routes or within areas that are considered to be fish feeding areas, (3) within this location, a surface sea height anomaly (Ocean Eddy) is defined using satellite s.s.h. data, and (4) applying a fertilizer that contains an Iron compound within the Ocean Eddy.

### FIELD OF THE INVENTION

This invention relates to production and sustainable production of seafood in ocean waters, environmental science and ocean ecosystem restoration.

### BACKGROUND OF THE INVENTION

Commercial and artisanal (private) fisheries around the world have been in a state of decline and in some cases, complete collapse. The most common cause attributed to this decline is over-fishing by large commercial scale fisheries, and loss of habitat.

Despite habitat restoration in freshwater for anadromous species and implementation of fishing quotas, the decline in fisheries continues.

A factor that is often ignored in attributing cause to declining fisheries is availability of sufficient food required for survival in large numbers. Obviously, if fish do not have sufficient food source along their migratory routes or primary feeding grounds, it will negatively impact their health and numbers.

Most oceanic fish consume zooplankton, or consume other fish and organisms that have themselves consumed zooplankton as their main food source. Zooplankton in turn feed on phytoplankton, which are primarily single cell photosynthetic life forms that form the base of the entire ocean ecosystem.

Therefore, it can be shown that production of fish and phytoplankton abundance are directly and causally related (Sheldon, R. W., Sutdiffe, W. H. Jr., Paranjape. M. A. (1977)).

Unfortunately, studies have shown that phytoplankton abundance has been in decline over this century and ocean “deserts” are growing (http://www.mmab.ca/lib/exe/fetch.php?media=pubs:irwin-2009-grt-deserts.pdf). This decline has been measured to be an average of 1% of the global median per year (Boyce, D. G., Lewis, M. R., Worm, B. (2010)).

### DESCRIPTION OF PRIOR ART

In the field of production of seafood are described methods for improving the production focused mainly in the way that the nutrients are incorporated to the water.

Patent document U.S. Pat. No. 5,433,173 A (Markles I) entitled “Method of improving production of seafood” with priority date of Apr. 28, 1994 discloses a method of improved seafood production. Markels specifies a fertilizer that is comprised of a float material bonded to a fertilizer that dissolves slowly in the ocean.

Patent document U.S. Pat. No. 6,729,063 B1 (Markels II) entitled “Method of increasing the fish catch in the ocean” with a priority date of Nov. 18, 2002 describes a process similar to the previously described patent also by Markels (Markels I). Markels II specifies an oceanic condition that is low on one or more nutrients, and uses a fish attractive device (FAD), and a fertilizer comprising of an iron chelate and other specific fertilizer formulations.

### BRIEF DESCRIPTION OF THE DRAWINGS

FIG. 1 shows the area of an experiment. In this illustration purple, blue, green and yellow represent areas of low chlorophyll, and orange and red represent areas of high chlorophyll. “B” marks the location of the experiment prior to the addition of Iron, and “A” marks the same location after the addition of Iron. Visualization source: NASA.

FIG. 2 shows a visualization of Surface Sea Height (SSH) used to identify ocean eddies. The red circle shows the ocean eddy used in the experiment. Data Source: NASA.

FIG. 3 shows a graph of Chlorophyll levels in the area of the experiment from 1997 until 2014. In mid 2008 a Chlorophyll anomaly was created from an Iron deposition into the area of the experiment from a Volcanic eruption and was not related to the experiment. The anomaly shown in mid 2012 was due to the experiment. Visualization Source: NASA

FIG. 4 shows an example of improvement in fisheries in Alaska in 2013. Data Source: Department of Game and Fisheries Alaska

### SUMMARY

The invention pertains to improving fish productivity in the open ocean. Specifically, this invention describes a process and method that creates an increase in the food source that ocean fish consume, thus decreasing their mortality and improving their health and size.

### DETAILED DESCRIPTION OF INVENTION

Global fisheries vary in productivity due to many factors that may include overfishing. However, one of these factors, namely ocean food supply for fisheries, can be improved by using Iron based fertilizers in certain ocean areas under specific and well defined ocean conditions that would result in restoration of historic phytoplankton conditions which in turn supports robust growth of zooplankton biomass—the most important food source for oceanic fish.

In 1988 Oceanographers John Martin and Steve Fitzwater provided compelling evidence that in certain ocean areas insufficient Iron in seawater limits the growth of phytoplankton (Martin, J., Fitzwater. S. (1988)). Further studies such as Geider & La Roche (Geider, R. La Roche, J.(1994)) confirm the concept of iron-limitation being a major factor in phytoplankton abundance.

Phytoplankton abundance recovers very quickly when Iron is introduced into the Ocean. The August 2008 eruption of the Kasatochi volcano in the subarctic North Pacific Ocean transported Iron rich volcanic dust into much of the North East Pacific, which rapidly initiated one of the largest phytoplankton blooms ever observed (Hamme, R. C. et al. (2010)). This plankton bloom was well within known Salmon migration routes. A further study of this event links an unprecedented increase of Sockeye salmon to this plankton abundance Parsons T, Whitney F, (2012).

Therefore, man-made Iron deposits into the Ocean, simulating natural Iron transport, may manifest large plankton blooms which in turn provide an abundant food source for fish. If plankton blooms can be generated through Iron fertilization that are within the feeding areas or migratory routes of fish, they will be exposed to a more abundant food source which in turn will decrease their mortality and increase their size and weight.

It has to be noticed that for this process to be effective, Iron fertilization must be done in specific parts of the ocean that meet a series of important criteria. The chemistry of the ocean must also meet select criteria and the fertilization compound must be specifically defined.

An improvement of plankton productivity within the feeding areas or migratory routes of oceanic fish can manifest a decrease in the mortality of oceanic fish and increase their size, providing for a sustainable improvement in commercial and artisanal fisheries.

This invention process requires that water soluble and bioavailable formulations of Iron are dispersed into the ocean in areas that are considered to be High Nutrient Low Chlorophyll (HNLC). HNLC ocean conditions describe areas of the ocean where the number of phytoplankton are low and fairly constant in spite of high macro-nutrient concentrations such as Phosphate, Nitrate and Silicic Acid. These regions are limited in their phytoplankton growth by a low concentration of bioavailable Iron and are therefore defined as Iron Limited.

An increase in the bioavailable Iron concentration in HNLC ocean conditions will result in a corresponding increase in Phytoplankton, followed by Zooplankton, which are the primary food source for fisheries.

However, the region where Iron is added to the ocean must meet other criteria as well. The selected regions for Iron addition must be within known fisheries feeding areas, or within fisheries migratory routes. This is because fisheries can only respond to increased food source if they are able to travel to the zones that have manifested improved conditions for their survival and growth.

Another criteria is that the zone of Iron addition is within a surface sea height anomaly called an Ocean eddy. This is because an Ocean eddy has the characteristics of macronutrient upwelling combined with an ability to contain the increased Iron concentration. An Ocean eddy provides reduced diffusion of the Iron, and thus is able to maintain the concentration for longer periods of time than Iron placed into the open Ocean. This reduced diffusion of Iron will allow the effect of the Iron addition to last longer and will function as an attractant for fish.

If this process is repeated on a regular basis, a long term sustainable improvement in fisheries productivity can manifest. This invention therefore may be defined as a sustainable fishery practice.

Some advantages of the present invention are:
The iron compound does not require any floating or supplementary fertilizer compound or device and is thus less expensive to produce said fertilizer as required by methods for improving seafood productivity.
The present invention does not specify nor require a fertilizer that dissolves slowly, allowing a more rapid action by said fertilizer.
The Ocean eddy provides reduced diffusion of the Iron, and thus is able to maintain the concentration for longer periods of time than Iron placed into the open Ocean.
The reduced diffusion of Iron will allow the Iron addition to last longer and will function as an attractant for fish.

The present invention specifies that the ocean conditions required are High Nutrient Low Chlorophyll (HNLC), and not merely low in a determined nutrient and the ocean must also be Low Chlorophyll. This important distinction permits the present invention to be more cost effective at manifesting improvement in seafood production. HNLC regions have been identified by the oceanographic community. Placing the iron compound into a surface sea height anomaly known as an Ocean Eddy improves the efficiency of the method and the fisheries productivity. The process of improving fisheries productivity in ocean waters according to the present invention comprises the following steps:
a) selecting a region of ocean defined as High Nutrient Low Chlorophyll (HNLC) based on a marine ecology definition;
b) narrowing the selection to a region of ocean being within or in close proximity to known areas of fish migration, or within areas that are considered to be fish feeding areas;
c) adding a metabolizable and water soluble Iron compound into the defined region of ocean; to increase growth of phytoplankton; determining the increase of the population of seafood; and
d) harvesting the increased production of seafood that results from the fertilization.

In an embodiment of the present invention, the iron compound can be selected from the group consisting of iron sulphate, Iron Oxide in a highly atomized form, Iron Carbonate, Iron Sulphide, Iron Vitriol, Iron Humate, a polysaccharide-Iron complex, an Iron salt formulation, among others.

The iron compound is placed into the surface of the seawater, preferably using dosing means, where those dosing means are selected from the group consisting of an aircraft, a surface ship, a barge or any floating vehicle or device.

A preferred embodiment of the invention, the iron compound is placed into an Ocean Surface Sea Height anomaly known as an Ocean Eddy.

### ILLUSTRATIONS

The following examples illustrate the claimed process and method. The illustrations are from an experiment to test the utility of the invention.

The disclosed information is illustrative, and other embodiments exist and are within the scope of the present invention.

A region of ocean was selected for an experiment. This ocean area satisfied one of the conditions that it was High Nutrient Low Chlorophyll (HNLC) and the location is within the migratory paths of Pacific Pink Salmon.

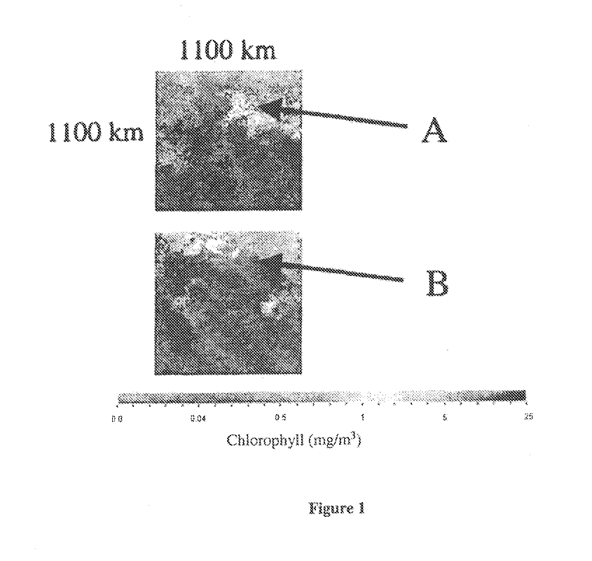

The area of the experiment is an 1100 km square as shown in FIG. 1 of the area. In this illustration purple, blue, green and yellow are areas of low chlorophyll, and orange and red are areas of high chlorophyll. “B” marks the location of the experiment prior to the addition of Iron, and “A” marks the same location after Iron was added. “A” shows a subsequent increase in the Chlorophyll levels within the area of the Iron Sulphate and Iron Oxide placement. Chlorophyll levels are an indicator of increased phytoplankton growth and productivity, and thus an increased food source for fisheries.

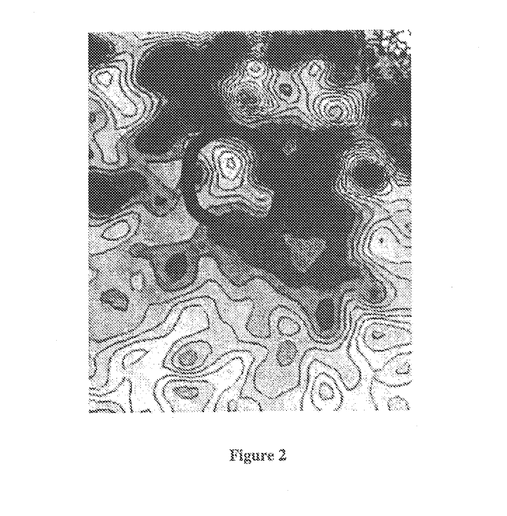

A second condition of the invention is that the Iron compound is placed within an ocean eddy. The red circle of FIG. 2 shows the ocean eddy that was used in the experiment.

The 100 tons of Iron Suplhate (FeSO₄) and 20 tons of Iron Oxide (Fe₂O₃) were placed using a ship as a dosing means in the approximate area marked in FIG. 2, These compounds were not combined with a float material, and were used ‘as is’ without modification.

The Chlorophyll levels were measured in the area of the experiment from 1997 until 2014.

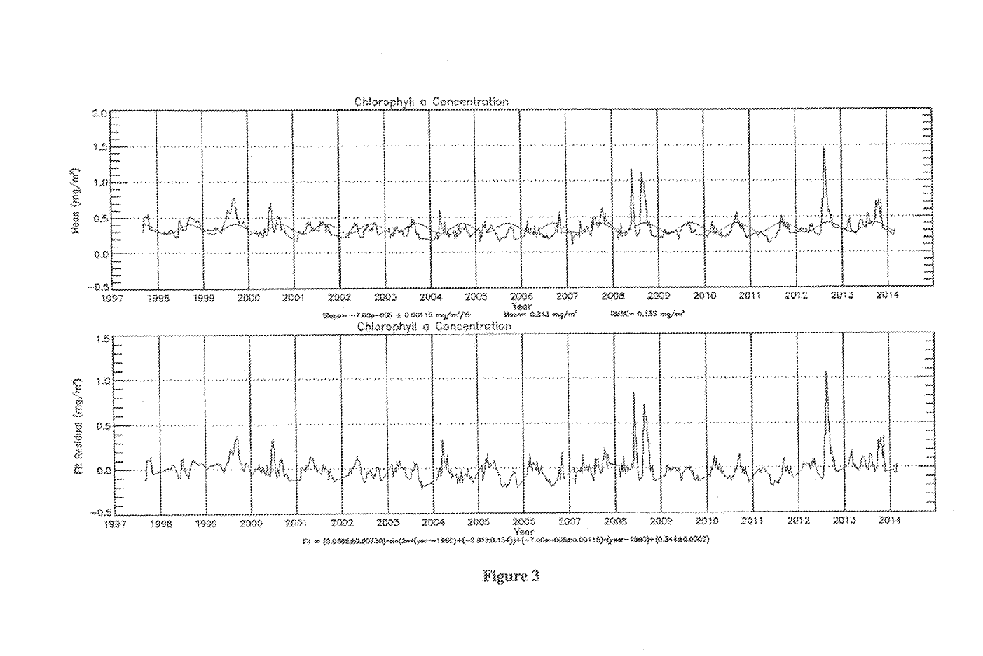

FIG. 3 shows a graph of the Chlorophyll levels, were in mid 2008 a Chlorophyll anomaly was created from an Iron deposition into the area of the experiment from a Volcanic eruption; this anomaly was not related to the experiment.

However, salmon returns in the following year were significantly elevated. The anomaly shown in mid 2012 was due to the experiment. Note that the Chlorophyll levels due to the experiment are the highest recorded since 1997.

In 2013, a Fraser River Pink Salmon run was forecast at 8.9 million fish by the Department of Fisheries and Oceans, Canada. The actual run was over 41 million fish. Table 1 shows the improvement in fisheries in British Columbia Canada according to this example. The data represents a fisheries improvement of 466% over the forecast run.

TABLE 1
Run status of Frase sockeye and pink salmon, week of Sep. 1 to Sep. 7, 2013. Improvement
in fisheries production, British Columbia Canada. Source: The Pacific Salmon Commission.

| | Sockeye | | | | | |
|---|---|---|---|---|---|---|
| | | | | | | Pink |
| | Management group | | | | Total | Total |
| | E. Stuart | E. Summer | Summer | Late | Fraser | Fraser |
| Mission passage (includes | 180,500 | 513,800 | 2,123,700 | 493,400 | 3,311,400 | na |
| Pitt, Alouette, Coquitlam) | | | | | | |
| Catch downstream of mission | 1,900 | 32,400 | 219,100 | 35,800 | 289,200 | 2,276,100 |
| Accounted run-to-date¹ | 182,400 | 546,200 | 2,342,800 | 529,200 | 3,600,600 | 41,580,000 |
| Run size adopted in-season² | 182,000 | 550,000 | 2,400,000 | 600,000 | 3,732,000 | 26,000,000 |
| Run size forecasted pre- | 211,000 | 253,000 | 3,718,000 | 583,000 | 4,765,000 | 8,926,000 |
| season | | | | | | |
| Area 20 timing adopted in- | 2/Jul | 25/Jul | 10/Aug | 17/Aug | | 29/Aug |
| season | | | | | | |
| Area 20 timing forecasted pre- | 5/Jul | 23/Jul | 3/Aug | 12/Aug | | 28/Aug |
| season | | | | | | |

¹For Pink salmon the accounted run to date is a reconstruction-based estimate.
²Run sizes are usually not adopted until after the peak of the run has passed through marine test fishery areas in Juan de Fuca and Johnstone Straits.

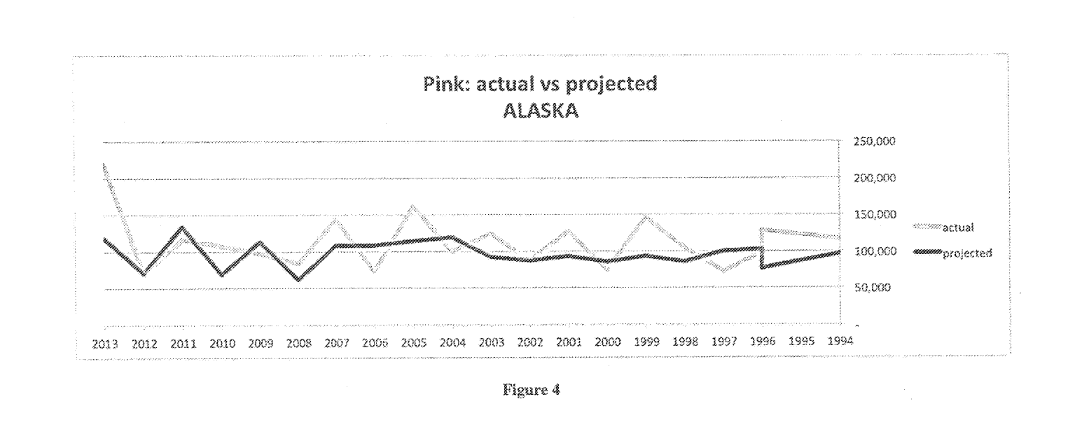

Finally, FIG. 4 shows an example of improvement in fisheries in Alaska in 2013. This graph shows an improvement of approximately 100% over the forecast run.

1. A process of improving fisheries productivity in High Nutrient Low Chlorophyll Ocean waters comprising the following steps:
a) selecting a region of ocean defined as High Nutrient Low Chlorophyll (HNLC) based on a marine ecology definition;
b) narrowing the selection to a region of ocean being within or in close proximity to known areas of fish migration, or within areas that are considered to be fish feeding areas;
c) narrowing the previous selection an Ocean Surface Sea Height anomaly known as an Ocean Eddy;
d) adding a bioavailable and water soluble Iron compound into the defined region of ocean to increase growth of phytoplankton;
e) determining the increase of the population of seafood; and
f) harvesting the increased production of seafood that results from the fertilization.

2. A process of improving seafood production according to claim 1, wherein the iron compound is iron sulphate.

3. A process of improving seafood production according to claim 1, wherein the iron compound is Iron Oxide in a highly atomized form.

4. A process of improving seafood production according to claim 1, wherein the iron compound is Iron Carbonate.

5. A process of improving seafood production according to claim 1, wherein the iron compound is Iron Sulphide.

6. A process of improving seafood production according to claim 1, wherein the iron compound is Iron Vitriol.

7. A process of improving seafood production according to claim 1, wherein the iron compound is Iron Humate.

8. A process of improving seafood production according to claim 1, wherein the iron compound is a polysaccharide-Iron complex.

9. A process of improving seafood production according to claim 1, wherein the iron compound is an Iron salt formulation.

10. A process of improving seafood production according to claim 1, wherein the iron compound is placed into the surface of the seawater.

11. The process of improving seafood production according to claim 10, wherein the iron compound is placed to the surface using dosing means.

12. The process of improving seafood production according to claim 11, wherein the dosing means are selected from the group consisting of an aircraft, a surface ship, a barge or any floating vehicle or device.

13. A process of improving seafood production according to claim 1, wherein the Iron compound is placed into an Ocean Surface Sea Height anomaly known as an Ocean Eddy.
